(19) United States
(12) Patent Application Publication
(10) Pub. No.: US 2007/0023226 A1
(43) Pub. Date: Feb. 1, 2007

(54) Specialized, tapered bolts for rear axle shafts

(76) Inventors: Suheal N. Hawash, Fort Wayne, IN (US); Henry A. Gallmeyer, Decatur, IN (US); Gregg E. Monteith, Huntertown, IN (US); Michael S. Freed, Fort Wayne, IN (US); Gregory P. Voglewede, Decatur, IN (US); Gregory Mettler, Fort Wayne, IN (US); Roy T. Tope, Woodburn, IN (US); Terry J. Simpson, Glencoe (CA)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 11/190,668

(22) Filed: Jul. 26, 2005

(51) Int. Cl. B60K 17/00; F16B 23/00

(52) U.S. Cl. 180/337; 180/378; 411/405

(57) ABSTRACT

A tapered-head bolt for use in attaching axle shafts to hub assemblies in heavy-duty, powered, non-steering (full-floating) axles. Use of the tapered-head bolt eliminates the deficiencies and complexity associated with the current use of studs, cone-nuts, cone-washers, and/or lock nuts.

### BACKGROUND OF INVENTION

This invention relates to fasteners used on an axle assembly for a ground traveling vehicle. Specifically, it relates to the fasteners used to attach the axle shafts of a heavy-duty driving rear axle to the hub assemblies. In lieu of the studs, cone-nuts, cone-washers, lock washers, and/or lock nuts that are conventionally utilized, a single set of specialized, tapered-head bolts securely retain the flanges at the end of the axle shafts to the hub castings.

### SUMMARY

Mobile ground traveling vehicles are commonly configured with one or more wheel and axle assemblies. These axles are provided in a large number of different types, depending on whether the axle is powered or non-powered, whether the axle is steering or non-steering, and the weight bearing capacity of the axle. Powered, non-steering axles consist of a hollow tube or housing with an enclosure near its center for containing a differential gear. This differential gear receives power from the vehicle engine, and communicates it to the wheels via axle shafts.

On vehicles having light-duty, powered, non-steering axles, the axle shafts not only transmit power to the wheels, but also support the weight of the vehicle by providing a load path from the axle housing to the wheel assemblies through one or more bearings. An axle configured in this way is known in the vehicle manufacturing industry as a semi-floating axle. Medium and heavy duty vehicles are more commonly provided with one or more heavy-duty, powered, non-steering axles. The axle shafts in these heavy-duty, powered, non-steering axles do not bear the weight of the vehicle. Instead, the wheel assemblies are mounted upon hub assemblies, which rotate on bearings mounted directly to the axle housing. The axle shafts extend through the center of these hub assemblies, the bearings, and the end of the axle housing. Flanges at the termini of the axle shafts are then fastened to the hub assemblies, thus providing power to them, and thereby to the wheel assemblies which are mounted to them. An axle configured in this way is known in the vehicle manufacturing industry as a full-floating axle.

Light-duty, powered, non-steering (semi-floating) axles are provided with seals located at the ends of the axle housing that prevent the egress of axle lubricant that is contained within the axle housing. Heavy-duty, powered, non-steering (full-floating) axles are not provided with seals in these locations, as the axle lubricant also serves to lubricate the bearings upon which the hub assemblies rotate. Therefore, there are seals between the hub assemblies and the axle housing, which are located on the inboard sides of the inner hub bearings. Additionally, there are gaskets or seals located between the flanges of the axle shafts and the face of the hub assemblies. These seals prevent seepage of the axle lubricant between the axle shaft flanges and the face of the hub assemblies. As the power and torque delivered to the driving wheels must pass through these joints, considerable difficulty has been encountered in maintaining the integrity of the seals therebetween.

A variety of fasteners have been used to attach the flanges of the axle shafts to the hub assemblies, and more importantly, attach them in a sufficiently secure manner such that no relative movement occurs between the axle shaft flanges and the hub assemblies. Currently, normal industry practice involves the use of studs that are inserted into threaded holes in the face of the hub castings. The axle shafts are installed into the axle with conically-bored holes in the flanges oriented over these studs, and cone-nuts or flange-nuts and cone-washers are used to provide the clamp load upon the axle shaft flanges. The studs are provided with any of a number of different threads and shanks, depending on several factors, including the metallurgy of the hub castings, the distance from the axle shaft bearings, and the type of nuts and washers. The cone-nuts or cone-washers are provided with a conical or tapered face, which is used in conjunction with conically-bored or tapered holes provided in the axle shaft flanges, such that the interface between the nuts and the axle shaft flanges provide a piloting, or self-centering, connection.

There are several significant drawbacks to the current use of studs, nuts, washers, and/or lock-washers to securely fasten the axle shaft flanges to the hub assemblies. Not the least of these drawbacks is the expense of manufacturing and assembling so many specialized fastener components. Typically, the studs are inserted into the hub castings prior to final assembly of the vehicle. Because the studs are threaded at both ends, they do not present a convenient gripping surface, such as a hex-head, so that they may be easily torqued to a consistent torque value. In addition, the heavy-vehicle manufacturing industry has a strong incentive to reduce vehicle weight. As a result, the amount of material used in the hub castings has been highly optimized. When studs are pre-torqued by bottoming the threads in a blind hole, this pre-stresses both the stud and the parent material. In order to minimize this pre-stress, and thereby allow for greater optimization of the hub castings, common industry practice has evolved to coating the threads of the studs, or a portion of them, with a thread-locking substance, such as Loctite®, and torquing them to a lesser value. The use of a thread-locking substance again adds cost and involves greater time in assembly.

Another significant drawback to the current use of studs, nuts, washers, and/or lock-washers involves the number of slip-planes or degrees-of-freedom between the individual fastener components. Any given assembly of two or more components must involve a certain amount of tolerance between the mating surfaces. For example, if a given straight-threaded fastener is inserted into a threaded hole, there is a small but measurable amount of possible movement between the fastener and the parent material. If this were not so, the fastener could not be inserted into the hole. More rigorous tolerances make possible the minimization, but not the elimination of this movement. When the fastener is torqued to an appropriate value, this relative movement appears to be eliminated, but in fact can and does still occur under greater force.

The same principle operates between the nut and the stud. The interface between the stud and the axle shaft flange sometimes involves the use of a clearance hole, and other times involves the use of a conically-bored, or tapered hole and a cone-nut or cone-washer. In the case of the use of a clearance hole, there is much opportunity for relative movement between the axle shaft flange and the hub casting. This type of installation relies greatly and imperfectly on the clamp load produced to eliminate this relative movement. In the case of the use of a cone-nut or cone-washer, the cone-nut or cone-washer wedges itself tightly in the hole in the axle shaft flange. However, there is still the potential of movement between the cone-nut, stud, and hub casting, or to a greater degree, between the nut, cone-washer, stud, and hub casting. Some installations have even involved the use of lock-washers, especially when the amount of detrimental relative movement between the axle shaft flange and the hub casting caused the fasteners to loosen. The addition of a lock-washer to the assembly often solved the problem of the fasteners loosening, but contributed to the problem of seal failure, due to the addition of a degree of freedom of movement under high stress loads.

It has been known in former times in the medium and heavy vehicle manufacturing industry to attempt to use bolts, in place of the studs, nuts, washers, and lock-washers. However, prior to this invention, the use of bolts has been problematic. Several approaches have been used. The primary difference between the approaches has been whether to use a clearance hole in the axle shaft flange, or whether to use a close tolerance fit between the bolt and the axle shaft flange.

The use of a close tolerance fit accomplishes the minimization of the relative movement, but has several significant problems of its own. One problem is the fact that use of a close tolerance fit between the bolt and the axle shaft flange requires very close, and therefore expensive, tolerances between the location of the holes in the axle flange, and the threaded holes in the hub casting. Another problem with the use of a close tolerance fit between the bolt and the axle shaft flange, involves the alignment of the axle shaft flange and the hub assembly during vehicle assembly. The axle shaft is typically a heavy component. Depending on bearing location within the axle housing, some of this weight had to be born by the assembling individual, while attempting to align the holes and pilot the bolt into the threads of the hub casting. These two problems combined have caused the industry to avoid the use of close tolerance fitted bolts as fasteners between the axle shaft flange and the hub assembly.

The use of a clearance fit between bolts and the axle shaft flange reduces the difficulty associated with aligning the bolts and the threaded holes in the hub casting. However, it allows for potentially the greatest and most detrimental movement between the axle shaft flange and the hub assembly.

The invention disclosed herein solves many of the problems of the prior art. It involves the use of specialized, tapered-head bolts, while reducing the cost of both hardware and assembly as compared to the use of studs, nuts, washers, and lock-washers. Conical holes are provided in the axle shaft flanges, that allow for the wedging and self-centering effect between the specialized, tapered-head bolt and the axle shaft flange. The shaft of the specialized, tapered-head bolt is of a lesser diameter than the small diameter of the tapered-head. In this way, sufficient clearance is provided between the specialized, tapered-head bolt and the axle shaft flange for more convenient assembly. The number of slip-planes or degrees-of-freedom between the axle shaft flange and the hub casting are reduced to one, versus the potential four slip-planes or degrees-of-freedom when studs, nuts, cone-washers, and lock-washers are used, or the potential three slip-planes or degrees-of-freedom when historically bolts and lock-washers were used. Because of the wedging, and thus statically-orienting, effect between the specialized, taper-head bolts and the axle shaft flange, even the remaining one degree-of-freedom between the bolt threads and the threads in the hub casting, is minimized to a great degree.

The invention as presented is a solution to the problem of seal failure between axle shaft flanges and hub assembly, which is a result of relative movement between those components when under high stress. It reduces the cost and complexity of assembly associated with the use of studs, nuts, cone-washers, and lock-washers to attach axle shaft flanges to hub assemblies on heavy-duty, powered, non-steering (full-floating) axles. It may reduce, or at least will be competitive with the component costs associated with studs, nuts, cone-washers, and lock-washers.

The figures listed illustrate a vehicle with at least one heavy-duty, powered, non-steering (full-floating) axle, having axle shaft flanges that attach to hub assemblies. The prior-art fasteners used to attach axle shaft flanges to hub assemblies are shown, as well as the specialized tapered-head bolt that is the embodiment of the invention disclosed.

### DRAWINGS

FIG. 1—A top view of a vehicle having at least one heavy-duty, powered, non-steering (full-floating) axle.

FIG. 2—A view of a heavy-duty, powered, non-steering (full-floating) axle.

FIG. 3—An exploded view of an axle shaft having a flange, a hub assembly, and an axle shaft seal.

FIG. 4—A cross section view of the wheel end of a heavy-duty, powered, non-steering (full floating) axle having an axle shaft with a flange, a hub assembly, and bearings and seals.

FIG. 5—An exploded view of a prior art installation utilizing studs and cone-nuts.

FIG. 6—A view of prior art cone-nuts.

FIG. 7—An exploded view of a prior art installation utilizing studs, nuts, and cone-washers.

FIG. 8—A view of prior art cone-washers.

FIG. 9—An exploded view of an embodiment of the invention, an installation utilizing specialized tapered-head bolt.

FIG. 10—A view of an embodiment of the invention, the specialized tapered-head bolt.

FIG. 11—A view of another embodiment of the invention, the specialized tapered-head bolt.

FIG. 12—A view of an embodiment of the invention, the specialized tapered-head bolt in relation to an axle shaft flange with holes.

### DETAILED DESCRIPTION

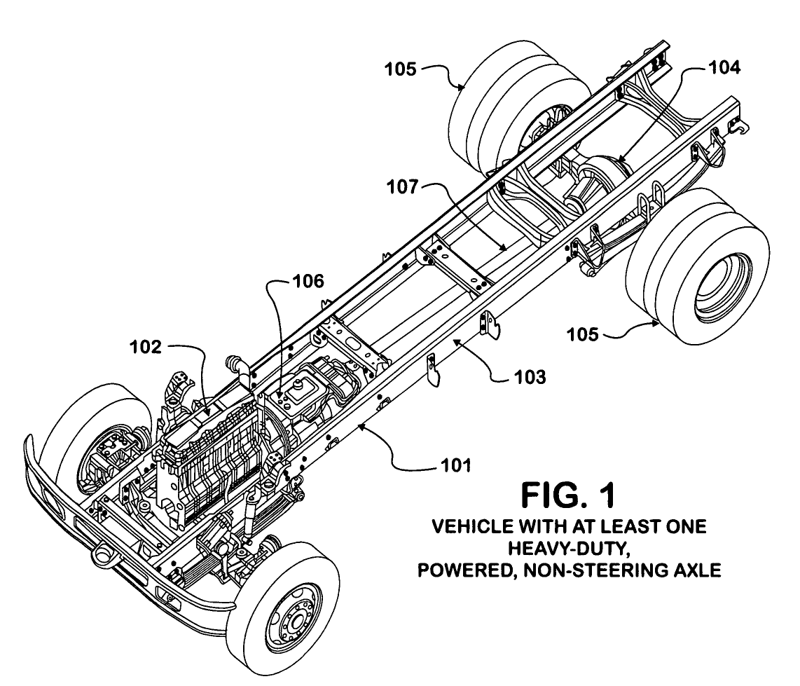

The vehicle 101 shown in FIG. 1 has an engine 102 attached to a chassis 103. The vehicle 101 also has at least one heavy-duty, powered, non-steering (full-floating) axle 104 attached to chassis 103. The heavy-duty, powered, non-steering (full-floating) axle 104 is provided with wheel and tire assemblies 105. The engine 102 provides power to a transmission 106, which in turn provides power to a propeller shaft 107. The propeller shaft 107 thereby provides power to the heavy-duty, powered, non-steering (full-floating) axle 104 and to wheel and tire assemblies 105.

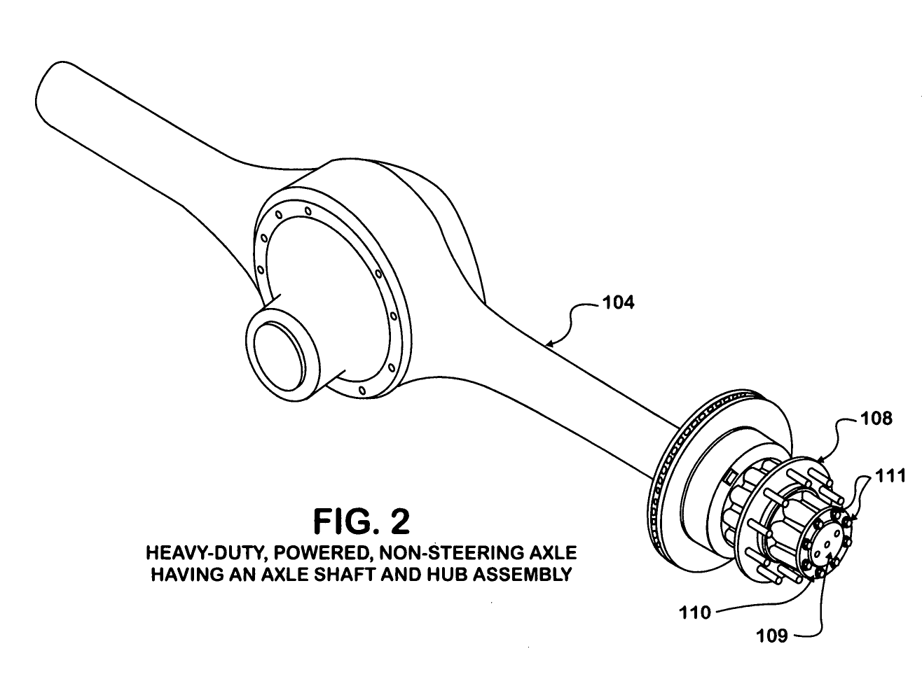

FIG. 2 shows a heavy-duty, powered, non-steering (full-floating) axle 104, similar to the heavy-duty, powered, non-steering (full-floating) axle 104 appearing attached to chassis 103 in FIG. 1. The heavy-duty, powered, non-steering (full-floating) axle 104 in FIG. 2 is provided with a hub assembly 108 and an axle shaft 109 having an axle shaft flange 110. The axle shaft flange 110 is attached to hub assembly 108 by means of axle shaft fasteners 111. The wheel and tire assemblies 105, not shown, are attached to hub assembly in a conventional manner.

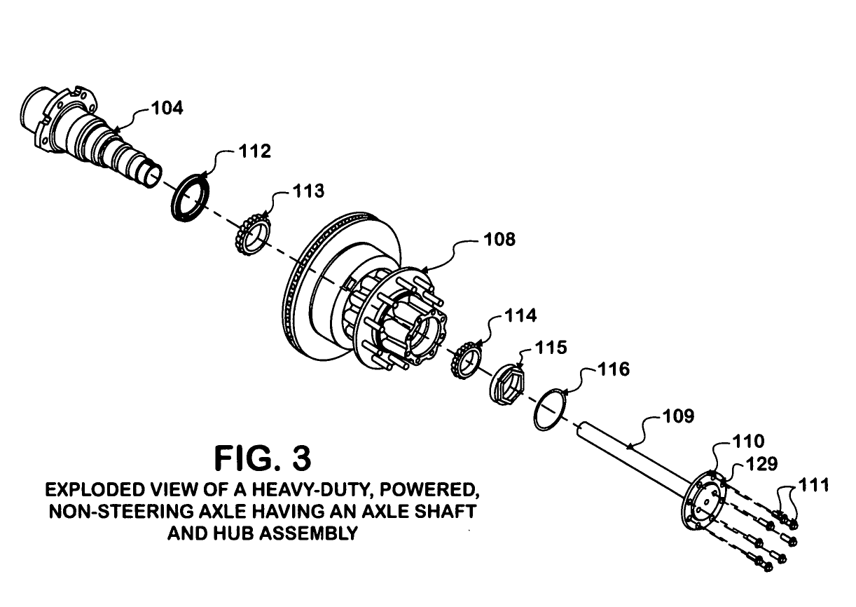

FIG. 3 shows an exploded view of the axle shaft 109 and the hub assembly 108, as well as their manner of attachment to the heavy-duty, powered, non-steering (full-floating) axle 104, a partial view of which is illustrated. The hub assembly 108 is provided with an inner wheel seal 112, an inner bearing set 113, an outer bearing set 114, and a primary wheel-nut 115. When assembled, the hub assembly 108 rotates upon the inner bearing set 113 and the outer bearing set 114, and is retained by the primary wheel-nut 115. The axle shaft 109 is inserted through the hub assembly 108 and into the heavy-duty, powered, non-steering (full-floating) axle 104. The axle shaft 109 is further provided with an axle shaft seal 116. The axle shaft seal 116 and the inner wheel seal 112 serve to retain the axle lubricant 117, which is not shown in FIG. 3. The axle shaft 109, having the axle shaft flange 110 with conically-bored axle shaft flange holes 129, is attached to the hub assembly 108 by means of the axle shaft fasteners 111.

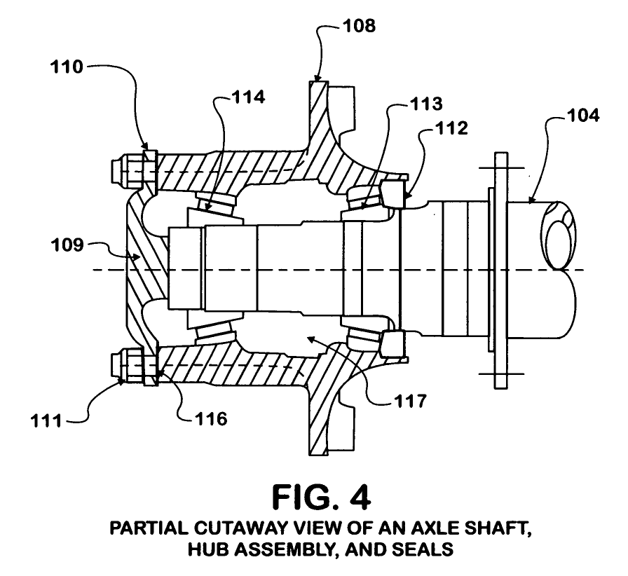

FIG. 4 shows a partial cutaway view of the axle shaft 109 and the hub assembly 108. The heavy-duty, powered, non-steering (full-floating) axle 104 is partially shown, and is not shown cutaway. Again, the hub assembly 108 is provided with an inner wheel seal 112, an inner bearing set 113, and an outer bearing set 114. The axle shaft 109 is shown inserted through the hub assembly 108 and into the heavy-duty, powered, non-steering (full-floating) axle 104. The axle shaft 109, having the axle shaft flange 110, is further provided with an axle shaft seal 116, and is retained to the hub assembly 108 by means of axle shaft fasteners 111. The axle lubricant 117 is shown lubricating the inner bearing set 113 and the outer bearing set 114. FIG. 4 illustrates the manner in which the axle lubricant 117 is retained by the axle shaft seal 116 and the inner wheel seal 112.

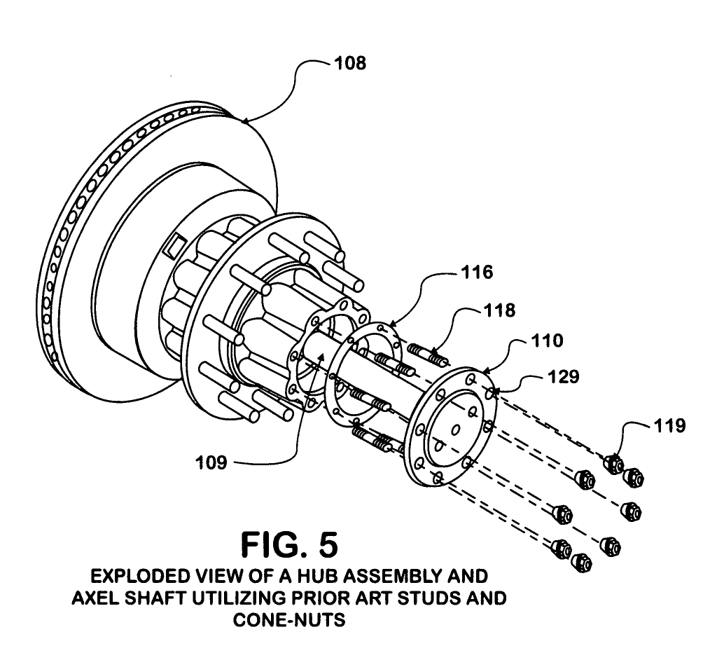

FIG. 5 shows an exploded view of the hub assembly 108 and the axle shaft 109. The heavy-duty, powered, non-steering (full-floating) axle 104 is not shown. The axle shaft 109 is provided with the axle shaft flange 110 having conically-bored axle shaft flange holes 129, and is shown partially inserted into the hub assembly 108. The axle shaft seal 116 is shown in its relative position. Prior art fasteners are shown, consisting of studs 118 and cone-nuts 119. By means of the studs 118 and the cone-nuts 119, the axle shaft flange 110 is attached to the hub assembly 108.

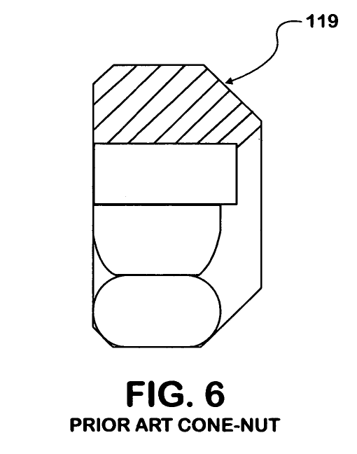

FIG. 6 shows a partially sectioned view of a prior art cone nut 119.

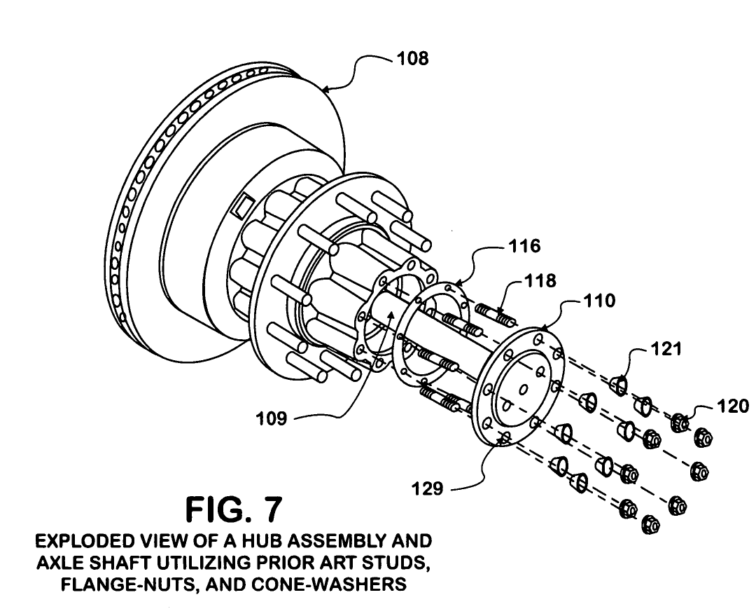

FIG. 7 shows an exploded view of the hub assembly 108 and the axle shaft 109, similar to the hub assembly 108 and axle shaft 109 shown in FIG. 5. Again, the heavy-duty, powered, non-steering (full-floating) axle 104 is not shown. The axle shaft 109 is provided with the axle shaft flange 110 having conically-bored axle shaft flange holes 129, and is shown partially inserted into the hub assembly 108. The axle shaft seal 116 is shown in its relative position. Prior art fasteners are shown, consisting of studs 118, flange-nuts 120, and cone-washers 121. By means of the studs 118, the flange-nuts 120, and the cone-washers 121, the axle shaft flange 110 is attached to the hub assembly 108.

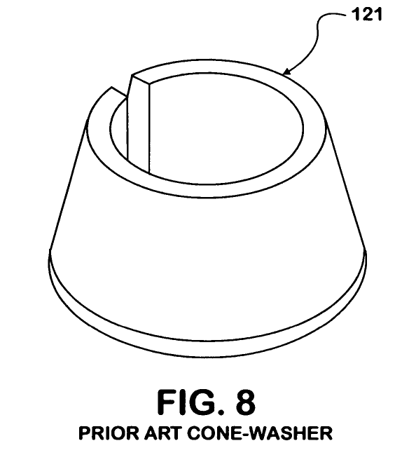

FIG. 8 shows a prior art cone-washer 121.

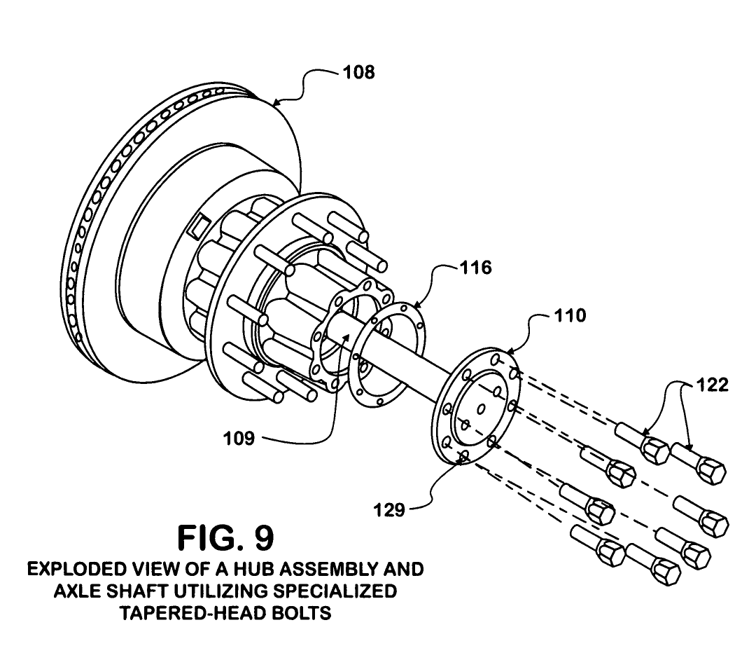

FIG. 9 shows an exploded view of the hub assembly 108 and the axle shaft 109, similar to the hub assembly 108 and axle shaft 109 shown in FIG. 5. Again, the heavy-duty, powered, non-steering (full-floating) axle 104 is not shown. The axle shaft 109 is provided with the axle shaft flange 110 having conically-bored axle shaft flange holes 129, and is shown partially inserted into the hub assembly 108. The axle shaft seal 116 is shown in its relative position. An embodiment of the invention, the specialized, tapered-head bolts 122 are shown, by means of which, the axle shaft flange 110 is attached to the hub assembly 108.

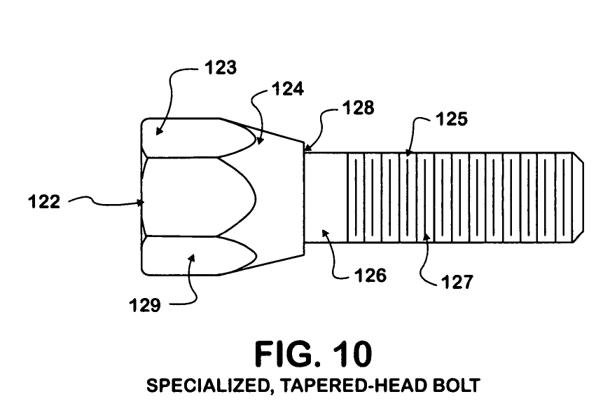

FIG. 10 shows a representative view of an embodiment of the invention, a specialized, tapered-head bolt 122. The specialized, tapered-head bolt 122 is provided with a drivable head 123, and a bolt shaft 125. The drivable head 123 is further provided with a tapered shoulder 124 and a hexagonal section 129. The bolt shaft 125 is further provided with a non-threaded region 126, and a threaded region 127. Alternately, the bolt shaft 125 may be provided with a threaded region 127 only, which may extend to the drivable head 123. According to the invention, the nominal diameter of the bolt shaft 125 is less than the minor diameter of the tapered shoulder 124, such that there is a step 128 at the point where the bolt shaft 125 meets the drivable head 123.

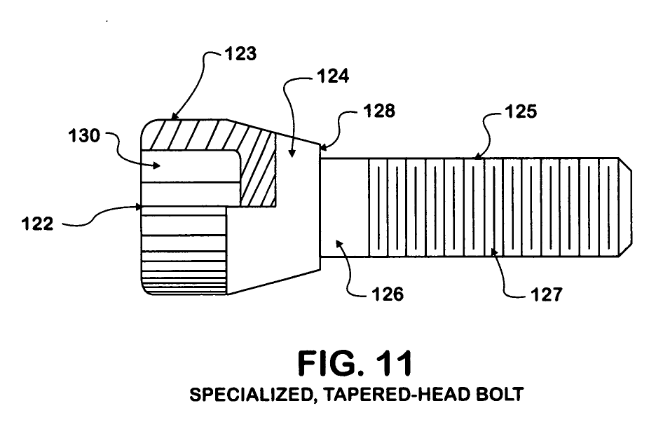

FIG. 11 shows an alternate embodiment of the invention, a specialized, tapered-head bolt 122. The specialized, tapered-head bolt 122 shown in FIG. 11 is again provided with a drivable head 123, and a bolt shaft 125. The drivable head 123 is further provided with a tapered shoulder 124 and a hexagonal depression 130. The bolt shaft 125 is further provided with a non-threaded region 126, and a threaded region 127. Alternately, the bolt shaft 125 may be provided with a threaded region 127 only, which may extend to the drivable head 123. According to the invention, the nominal diameter of the bolt shaft 125 is less than the minor diameter of the tapered shoulder 124, such that there is a step 128 at the point where the bolt shaft 125 meets the drivable head 123.

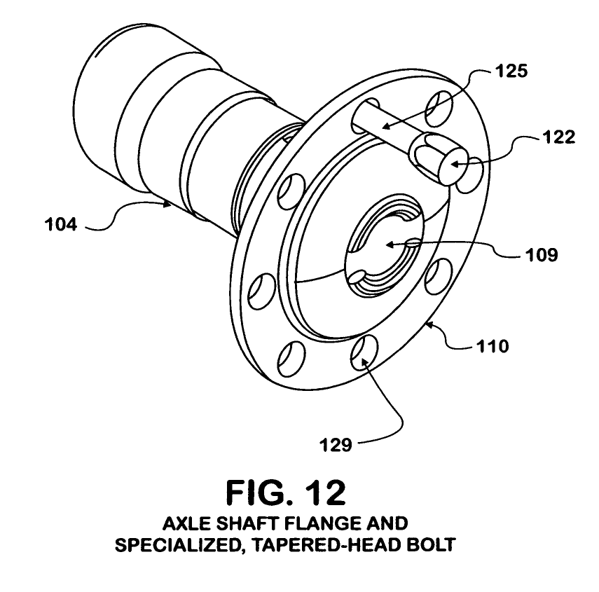

FIG. 12 shows an axle shaft 109, having an axle shaft flange 110 with conically-bored axle shaft flange holes 129, inserted into a heavy-duty, powered, non-steering (full-floating) axle 104, a partial view of which is shown. The hub assembly 108 is not shown in FIG. 11. The specialized, tapered-head bolt 122 is shown relative to the conically-bored axle shaft flange holes 129 in the axle shaft flange 110, into which the specialized, tapered-head bolt 122 would be inserted upon assembly. The bolt shaft 125 of the specialized, tapered-head bolt 122 is shown to be of a lesser diameter than the minor diameter of the conically-bored axle shaft flange holes 129. In this way, provision is made for convenient assembly of the axle shaft 109 to the hub assembly 108 (not shown), while maintaining a secure fit upon tightening.

Other permutations of the invention are possible without departing from the teachings disclosed herein, provided that the function of the invention is to provide a single-piece, fastener-centering, bolt-type fastener for use in attaching an axle shaft flange to a hub assembly. Other advantages to a vehicle 101 equipped with an axle shaft flange attached to a hub assembly by means of a single-piece, fastener-centering, bolt-type fastener may also be inherent in the invention, without having been described above.

We claim:

1. A mobile vehicle for operation on the ground, comprising:
a chassis;
at least one powered, non-steering, full-floating axle, said at least one powered, non-steering, full-floating axle having at least one axle shaft, said at least one axle shaft being provided with an axle shaft flange, said axle shaft flange being further provided with at least one conically-bored axle shaft flange hole, said at least one powered, non-steering, full-floating axle being further provided with at least one hub assembly, said at least one hub assembly being provided with at least one hole for receiving a threaded fastener; and
at least one tapered-head bolt, said tapered-head bolt being provided with a drivable head and a bolt-shaft, said drivable head being further provided with a tapered shoulder, and said bolt-shaft being provided with a threaded region, said at least one tapered-head bolt being inserted through said at least one conically-bored axle shaft flange hole and into said hole in said hub assembly.

2. The vehicle of claim 1, wherein:
said drivable head of said tapered-head bolt further comprises a hexagonal cross-section, said hexagonal cross-section being compatible with a standard wrench-type torsionally-driving device.

3. The vehicle of claim 1, wherein:
said drivable head of said tapered-head bolt further comprises a body, said body having an hexagonal depressed area, said hexagonal depressed area being compatible with a standard key-type torsionally-driving device.

4. The vehicle of claim 1, wherein:
said tapered shoulder located upon said drivable head of said tapered-head bolt further comprises a cone-shaped area, said cone-shaped area being located upon the end of said drivable head oriented towards said bolt-shaft.

5. The vehicle of claim 4, wherein:
said cone-shaped area further comprises an included angle of approximately 28 degrees.

6. The vehicle of claim 1, wherein:
said bolt-shaft of said tapered-head bolt being of a lesser nominal diameter than the minor diameter of said tapered shoulder of said tapered-head bolt.

7. The vehicle of claim 1, wherein:
said bolt-shaft of said tapered-head bolt being further provided with a non-threaded region in addition to said threaded region, said non-threaded region being located between said drivable head and said threaded region.

8. A tapered-head bolt for use in a vehicle having a chassis, said chassis having at least one powered, non-steering, full-floating axle, said at least one powered, non-steering, full-floating axle having at least one axle shaft, said at least one axle shaft being provided with an axle shaft flange, said axle shaft flange being further provided with at least one conically-bored axle shaft flange hole for insertion of said tapered-head bolt therethrough, said at least one powered, non-steering, full-floating axle being further provided with at least one hub assembly, said at least one hub assembly being provided with at least one hole for insertion of said tapered-head bolt, said tapered-head bolt comprising:
a drivable head, said drivable head being provided with a tapered shoulder; and
a bolt-shaft, said bolt-shaft being provided with a threaded region.

9. The tapered-head bolt of claim 8, wherein:
said drivable head further comprises a hexagonal cross-section, said hexagonal cross-section being compatible with a standard wrench-type torsionally-driving device.

10. The tapered-head bolt of claim 8, wherein:
said drivable head further comprises a body, said body having an hexagonal depressed area, said hexagonal depressed area being compatible with a standard key-type torsionally-driving device.

11. The tapered-head bolt of claim 8, wherein:
said tapered shoulder located upon said drivable head further comprises a cone-shaped area, said cone-shaped area being located upon the end of said drivable head oriented towards said bolt-shaft.

12. The tapered-head bolt of claim 11, wherein:
said cone-shaped area further comprises an included angle of approximately 28 degrees.

13. The tapered-head bolt of claim 8, wherein:
said bolt-shaft being of a lesser nominal diameter than the minor diameter of said tapered shoulder.

14. The tapered-head bolt of claim 8, wherein:
said bolt-shaft being further provided with a non-threaded region in addition to said threaded region, said non-threaded region being located between said drivable head and said threaded region.

15. A process of manufacturing a vehicle having a chassis, said chassis having at least one powered, non-steering, full-floating axle, said at least one powered, non-steering, full-floating axle having at least one axle shaft, said at least one axle shaft being provided with an axle shaft flange, said axle shaft flange being further provided-with at least one conically-bored axle shaft flange hole, said at least one powered, non-steering, full-floating axle being further provided with at least one hub assembly, said at least one hub assembly being provided with at least one hole for receiving a threaded fastener, said process comprising:
inserting said at least one axle shaft into said at least one powered, non-steering, full-floating axle;
orienting said at least one conically-bored axle shaft flange hole over said at least one hole in said at least one hub assembly; and
inserting a tapered-head bolt through said at least one conically-bored axle shaft flange hole and into said at least one hole in said at least one hub assembly, said tapered-head bolt having a drivable head, said drivable head being provided with a tapered shoulder, and said tapered-head bolt further having a bolt-shaft, said bolt-shaft being provided with a threaded region.
